(19) United States
(12) Patent Application Publication
(10) Pub. No.: US 2002/0005841 A1
(43) Pub. Date: Jan. 17, 2002

(54) Transmission method, receiving method, transmitter and receiver of digital video data

(76) Inventors: Won-seok Jung, Suwon-city (KR); Hyun-kuk Shin, Suwon-city (KR); Il Kim, Yongin-city (KR); Byung-jun Moon, Yongin-city (KR); Yong-sub Kim, Seoul (KR)

Correspondence Address: SUGHRUE, MION, ZINN,, MACPEAK & SEAS, PLLC, 2100 PENNSYLVANIA AVENUE, N.W., WASHINGTON, DC, 20037-3213, US

(21) Appl. No.: 09/823,275

(22) Filed: Apr. 2, 2001

(30) Foreign Application Priority Data
May 4, 2000 (KR) 00-23978

(51) Int. Cl. G09G 5/00

(52) U.S. Cl. 345/204

(57) ABSTRACT

A data transmission method which maintains the direct current (DC) balancing of each channel and compensates for the skew between channels when digital video data made up of graphic data, control data and clock data is transmitted in series via channels allocated to the data, and a data receiving method, a data transmitter and a data receiver, are provided. In this method, the disparity representing the degree of the direct current (DC) balancing of the graphic data is calculated whenever the graphic data is transmitted. The calculated disparities are accumulated whenever the graphic data is transmitted. Scrambling is performed in which, when the accumulated disparity does not amount to the predetermined critical value, the received graphic data is transmitted without change, and when the accumulated disparity amounts to the predetermined critical value, the received graphic data is inverted.

### BACKGROUND OF THE INVENTION

1. Field of the Invention

The present invention relates to transmission of digital video data, and more particularly, to a data transmission method which copes with the direct current (DC) balancing of each channel and the skew, that is, the temporal inconsistency, between channels when digital video data made up of graphic data, control data and clock data is transmitted in series via channels allocated to each of the data, and a data transmitter and a data receiver. The present application is based on Korean Patent Application No. 00-23978, which is incorporated herein by reference.

2. Description of the Related Art

Digital video signals generated from computers are transmitted to and displayed on a monitor. The digital video signal is made up of 8-bit graphic R/G/B data, control data representing whether synchronization data and graphic data are effective or not, and clock data for proper reproduction of transmitted data.

Faster data transmission is required due to an increase in the resolution of monitors, and cannot be coped with by current transistor-transistor level (TTL) signals. In order to solve this problem, research into the transmission of a digital video signal using optical transmission media has been conducted. When optical transmission media is used, R/G/B data, control data and a clock signal are allocated respectively to 3 channels, one channel and one channel, and each is transmitted in series in its corresponding channel.

In this serial transmission method, it is important to compensate for skew so that signals to be transmitted via each channel are accurately aligned by ascertaining the beginning and end of each of the data. According to a conventional parallel transmission method, even though the alignments of transmission signals between channels are inconsistent, just one or several pixels are distorted. However, in the serial transmission method, the entire screen may be distorted, so that it is important to compensate for skew.

Also, it is well known that, when a signal is biased, that is, when DC balancing is destroyed, in the transmission of digital signals, it is difficult for a receiving side to properly demodulate a received signal. Therefore, the DC balancing needs to be maintained to prevent biasing of the level of a signal.

### SUMMARY OF THE INVENTION

To solve the above problem, an objective of the present invention is to provide a method of transmitting digital video data, which copes with the direct current (DC) balancing of each channel and the skew between channels when digital video data made up of graphic data, control data and clock data is transmitted in series via channels allocated to each of the data.

Another objective of the present invention is to provide a data receiving method suitable for the method of transmitting digital video data.

Still another objective of the present invention is to provide a digital video data transmitter which copes with the DC balancing of transmitted data and the skew between channels.

Yet another objective of the present invention is to provide a digital video data receiver suitable for the digital video data transmitter.

To achieve the first objective, the present invention provides a method of transmitting digital video data made up of graphic data, control data and clock data in series through corresponding channels, the method including: calculating the disparity representing the degree of the direct current (DC) balancing of the graphic data whenever the graphic data is transmitted; accumulating the calculated disparities whenever the graphic data is transmitted; checking if the accumulated disparity amounts to a predetermined critical value; and performing scrambling in which, when the accumulated disparity does not amount to the predetermined critical value, the received graphic data is transmitted without change, and when the accumulated disparity amounts to the predetermined critical value, the received graphic data is inverted.

To achieve the second objective, the present invention provides a method of receiving digital video data made up of graphic data, control data and clock data and reproducing the graphic data, control data and clock data, the digital video data transmitted by channels in series, having the graphic data inverted or non-inverted to achieve DC balancing and compensate for the skew between channels and transmitted having a sync pattern having a specific bit pattern inserted thereinto, and the control data encoded and transmitted having surplus bits added according to a certain encoding rule to achieve the DC balancing and compensate for the skew between channels, the method including: ascertaining the beginning portion of effective graphic data by detecting the specific bit pattern from the serially-transmitted graphic data; truncating received graphic data starting from its ascertained beginning portion in units of a predetermined number of bits; and restoring the graphic data truncated in units of a predetermined number of bits to the original data that has not been inverted or non-inverted and encoded.

To achieve the third objective, the present invention provides an apparatus for transmitting digital video data made up of graphic data, control data and clock data in serial by channels, the apparatus including: a scrambler for scrambling the graphic data to achieve the DC balancing and compensate for the skew between channels; a control encoder for encoding the control data to achieve the DC balancing and compensate for the skew between channels; a graphic data parallel-to-serial converter for converting the output of the scrambler into serial data and outputting the serial data to a graphic channel; a control data parallel-to-serial converter for converting the output of the control encoder into serial data and outputting the serial data to a control channel; and a phase locked loop for receiving the clock data and providing an operation clock to the scrambler, the control encoder, the graphic data parallel-to-serial converter and the control data parallel-to-serial converter for outputting the operation clock to a clock channel.

To achieve the fourth objective, the present invention provides an apparatus for receiving digital video data made up of graphic data, control data and clock data and reproducing the graphic data, control data and clock data, the digital video data transmitted by channels in series, having the graphic data inverted or non-inverted to achieve DC balancing and compensate for the skew between channels and having the control data encoded to achieve the DC balancing and compensate for the skew between channels, the apparatus including: a descrambler for inverting or non-inverting the transmitted graphic data depending on the state of DC balancing and outputting a parallel signal in synchronization with a clock signal transmitted via a clock channel; a control decoder for decoding transmitted control data and outputting a parallel signal in synchronization with the clock signal transmitted via the clock channel; and a phase locked loop for receiving the clock signal transmitted via the clock channel and generating a clock signal to be provided to the descrambler and the control encoder or outputting the generated clock signal.

### BRIEF DESCRIPTION OF THE DRAWINGS

The above objectives and advantage of the present invention will become more apparent by describing in detail a preferred embodiment thereof with reference to the attached drawings in which:

FIG. 1 is a block diagram illustrating the configuration of a digital video data transceiving apparatus according to the present invention;

FIG. 2 is a block diagram illustrating the configuration of the digital video data transmitter shown in FIG. 1;

FIG. 3 is a flowchart illustrating the operation of the scrambler shown in FIG. 2;

FIG. 4 is a block diagram illustrating the configuration of the digital video data receiver shown in FIG. 1;

FIG. 5 illustrates the operation of the control synchronizer shown in FIG. 4;

FIG. 6 is a state transition diagram illustrating the operation of the control synchronizer shown in FIG. 4; and

FIG. 7 is a sub-state transition diagram illustrating the operation of each of the states shown in FIG. 6.

### DESCRIPTION OF THE PREFERRED EMBODIMENT

Digital video data is made up of R/G/B graphic data, control data and clock data. When the digital video data is transmitted in series, three channels for R/G/B graphic data, one channel for control data, and one channel for clock data, that is, a total of 5 channels, are required. In each of the channels, data is transmitted in series.

In a digital video data transmission method according to the present invention, graphic data and control data are encoded by different methods in order to achieve the direct current (DC) balancing and to compensate for the skew between channels.

(1) Encoding of Graphic Data

Graphic data undergoes encoding for DC balancing or encoding for compensation of the skew between channels, depending on the state of a data enable signal DE.

i) Encoding for DC Balancing

DC balancing is performed to prevent serially-transmitted data from being biased. When a control bit DE is high, that is, when data is effective, data is inverted or non-inverted to be transmitted. When the control bit DE is low, a sync bit selected to maintain the DC balancing is transmitted.

When the control bit DE is high, that is, when effective serial data is transmitted, the numbers of bits of 0 and 1 are in balance, so that the DC balancing is maintained. In order to achieve this, the disparities are measured and accumulated to measure the DC balancing of graphic data. When the accumulated disparity value reaches the upper limit or the lower limit, data to be transmitted is inverted, thus decreasing or increasing the accumulated disparity value.

The disparity is defined as the difference between the number of bits of 0 and the number of bits of 1 included in a data word (where, a word, which is a data processing unit, is made up of 8 bits). For example, if 4 bits of 0 and four bits of 1, that is, a total of 8 bits, form a data word, the disparity is zero. If 2 bits of 0 and 6 bits of 1 form a data word, the disparity is +4. Conversely, if 6 bits of 0 and 2 bits of 1 form a data word, the disparity is −4.

Whenever data is received, the disparity is calculated as described above, and calculated disparity values are accumulated.

When the accumulated disparity does not reach a predetermined limit value, for example, ±16, data is output without change. Conversely, when the accumulated disparity reaches ±16, data is inverted to be output. If the disparity of received data changes alternately to directions (+) and (−) every time data is received, it is difficult to reach the predetermined limit value. This means that transmitted data is not biased. Thus, the received data is output without change.

If the disparity of received data increases to either a direction (+) or (−) every time data is received, and reaches a predetermined limit value, this means that transmitted data is biased. Thus, the received data is output after being inverted, in order to prevent the transmitted data from being biased in the direction (+) or (−).

Also, a header bit made up of one bit is added to transmitted data to indicate whether data has been inverted or non-inverted. For example, when the header bit is 0, the transmitted data has been non-inverted. Conversely, when the header bit is 1, the transmitted data has been inverted.

ii) Encoding for Compensating for the Skew Between Channels

When a signal DE is low, that is, when effective data is not transmitted, a predetermined sync pattern is transmitted. A receiving side can correctly judge the beginning and end of transmitted data by detecting the sync pattern.

Also, a sync pattern in which the number of bits of 1 is balanced with the number of bits of 0 is selected, so that the DC balancing is maintained. The sync pattern also must have the same number of bits as transmitted data. When 9 bits into which 8 bits are converted are transmitted, the sync pattern can have a bit pattern of [111000101]. Among 9 bits, one bit is a header bit.

(2) Encoding of Control Data

Since control data itself has DE, it is not possible for control data to be encoded depending on the state of DE as in the case of graphic data. Accordingly, in the present invention, an extra surplus bit is added to the number of bits of control data, and the bit value of the surplus bit is determined by a predetermined encoding rule, so that the DC balancing is maintained, and the skew between channels is compensated for.

In an embodiment of the present invention, 4-bit parallel control data is converted into 9-bit serial control data (that is, data having 5 surplus bits). In the 9-bit serial control data, the original 4 bits are located at predetermined positions of the converted 9-bit control data without changing their values, and the remaining bits are determined by the values of pre-located bits and a predetermined encoding rule.

The encoding rule is set for DC balancing and skew compensation. A receiving side accurately ascertains the beginning and end of control data using the applied encoding rule. The encoding rule for received control data is described as follows.

Received control data (4 bits)→Output control data (9 bits)

| | |
|---|---|
| bit 3: V-Sync | bit 8: - V_Sync (surplus bit) |
| | bit 7: - V_Sync (surplus bit) |
| bit 2: H-Sync | bit 6: V_Sync |
| | bit 5: H_Sync |
| bit 1: DE | bit 4: - H_Sync (surplus bit) |
| | bit 3:DE |
| bit 0: reserved | bit 2: - DE (surplus bit) |
| | bit 1: reserved |
| | bit 0: - reserved (surplus bit) |

Here, “−” denotes an inversion.

In the applied encoding rule, the first two bits (bits 8 and 7) are the same, the last two bits (bits 1 and 0) are in a logically-NOT (opposite) relationship, bits 7 and 6 are in a logically-NOT (opposite) relationship, and bits 5 and 4 are in a logically-NOT (opposite) relationship.

As can be seen from the above-proposed example, received control bits keep their original values, and surplus bits have the opposite values to the values of the input control bits. Thus, transmitted control data keeps the DC balancing.

A receiving side checks whether the applied four encoding rules are violated or not, so that the beginning and end of control data can be accurately discerned.

In a digital video data receiving method according to the present invention, graphic data and control data are decoded by different methods in order to achieve the DC balancing and to compensate for the skew between channels.

(1) Decoding for Compensation of the Skew Between Channels

i) Skew Compensation for Graphic Data

The bits of graphic data are aligned and truncated in accordance with a sync pattern.

When a signal DE is low, a receiving side judges the beginning portion of graphic data from a sync pattern having a particular bit pattern inserted, and truncates the data starting from the beginning portion at intervals of a predetermined number of bits. In this way, the graphic data is converted into parallel data.

ii) Skew Compensation for Control Data

The bits of control data are aligned and truncated using the encoding rules applied upon encoding.

A receiving side judges the beginning portion of control data using the encoding rules applied to encode control data, and truncates the control data starting from the beginning portion at intervals of a predetermined number of bits. In this way, the control data is converted into parallel data.

(2) Decoding for DC Balancing

i) Decoding of Graphic Data

Graphic data is decoded by reversely applying the scrambling rule which is applied for encoding. A transmission side re-inverts inverted graphic data with reference to the header bit, thereby decoding the original data.

ii) Decoding of Control Data

Control data is decoded by excluding the surplus bits inserted upon encoding. That is, a transmission side excludes surplus bits since it knows the locations of the surplus bits, so that it can extract the original control bits.

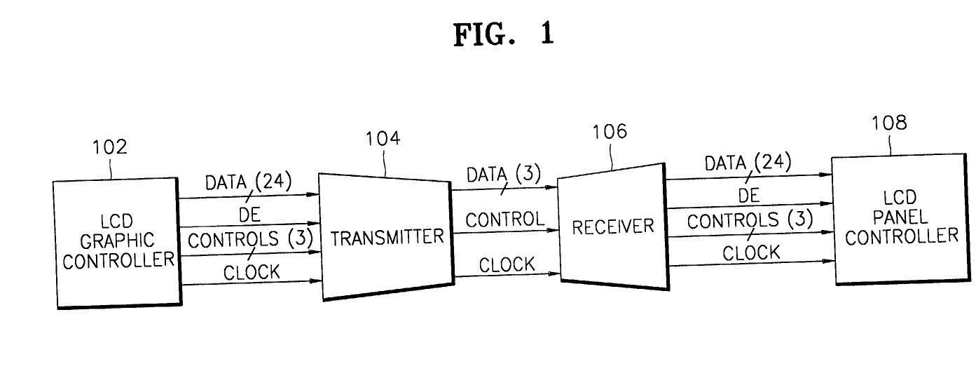

FIG. 1 is a block diagram illustrating the configuration of a digital video data transceiving apparatus according to the present invention. The digital video data transceiving apparatus includes a transmitter 104 for receiving parallel data made up of 24-bit video data, 4-bit control data and clock data output from a liquid crystal display (LCD) graphic controller 102 and converting the received data into serial data made up of 9 bits for each of five channels (3 channels for video data, one channel for control data and one channel for clock data). Here, the 24-bit video data is made up of 8 R bits, 8 G bits and 8 B bits, and the 4-bit control data is made up of V-Sync, H-Sync, data enable (DE) and reserved. The digital video data transceiving apparatus also includes a receiver 106 for receiving 9-bit serial data for each of the five channels from the transmitter 104 and restoring the received serial data to the parallel data made up of 24-bit video data, 4-bit control data and clock data. The 24-bit video data, 4-bit control data and clock data output from the receiver 106 is provided to an LCD graphic panel controller 108.

Data received by the transmitter 104 is parallel data, and 8 graphic data bits and 4 control data bits are transmitted for each clock. Meanwhile, data output from the transmitter 104 is serial data, and 9 graphic data bits and 9 control data bits are transmitted for each clock.

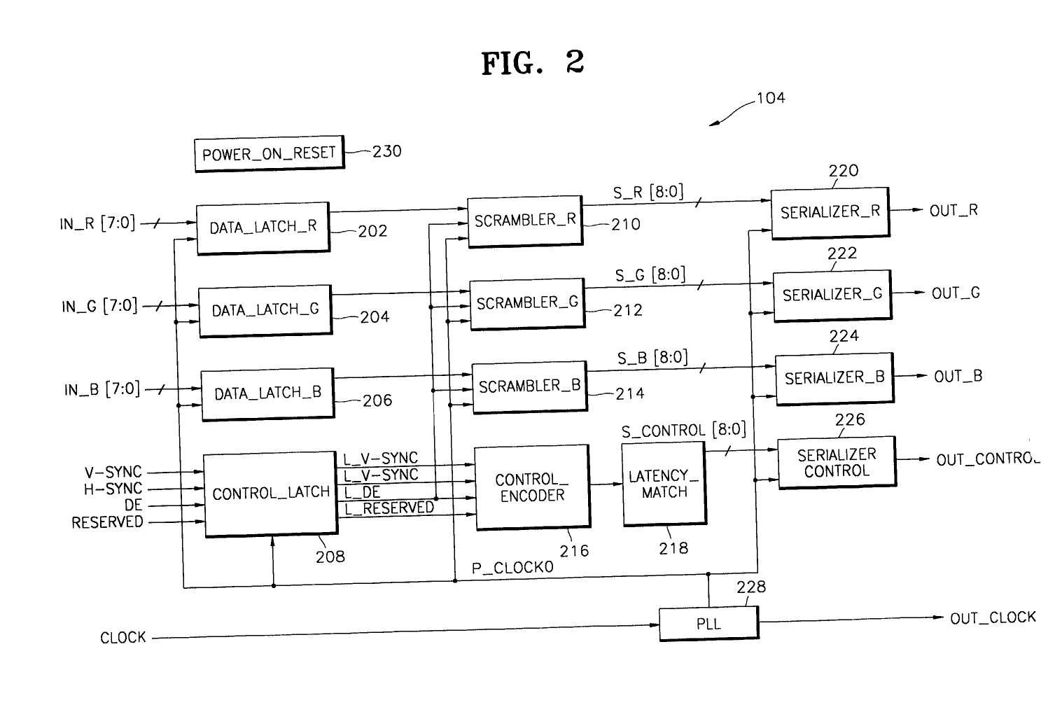

FIG. 2 is a block diagram illustrating the configuration of the digital video data transmitter 104 shown in FIG. 1. In FIG. 2, In_R[7:0], In_G[7:0] and In_B[7:0] are 8-bit parallel data of channels R, G and B output from the LCD graphic controller 102 shown in FIG. 1.

Also, Out_R, Out_G and Out_B are the 9-bit serial data of channels R, G and B output from the transmitter 104, Out_Control is the 9-bit serial data of a control channel output from the transmitter 104, and Out_Clock is the 9-bit serial data of a clock channel output from the transmitter 104.

The transmitter of FIG. 2 includes data latches 202, 204 and 206, a control latch 208, data scramblers 210, 212 and 214, a control encoder 216, a matching device 218, parallel-to-serial converters 220, 222, 224 and 226, and a phase locked loop (PLL) 228. The data latches 202, 204 and 206 latch received parallel data made up of 8-bit R data, 8-bit G data and 8-bit B data. The control latch 208 latches 4-bit control data. The data scramblers 210, 212 and 214 convert 8-bit parallel data output from the data latches 202, 204 and 206, respectively, into 9-bit parallel data by performing scrambling for DC balancing and compensation of the skew between channels with respect to the 8-bit parallel data. The control encoder 216 performs encoding for DC balancing and compensation of the skew between channels with respect to the 4-bit control data output from the control latch 208. The matching device 218 delays the 9-bit parallel control data from the control encoder 216 in order to compensate for the time interval between the 9-bit parallel control data from the control encoder 216 and the 9-bit parallel control data from the data scramblers 210, 212 and 214. The parallel-to-serial converters 220, 222, 224 and 226 convert the 9-bit parallel control data from the data scramblers 210, 212 and 214 and the 9-bit parallel control data from the matching device 218, respectively, into 9-bit serial data by synchronizing them with their internal clock signals. The PLL 228 generates an internal clock signal and an external clock signal in synchronization with a received clock signal.

The data latches 202, 204 and 206 latch In_R[7:0], In_G[7:0] and In_B[7:0] received from the LCD graphic controller 102 of FIG. 1 and outputs 1_R[7:0], 1_G[7:0] and 1_B[7:0] in synchronization with an internal clock signal P_Clock0, respectively.

The control latch 208 latches control bits V_Sync, H_Sync, DE and Reserved received from the LCD graphic controller 102 of FIG. 1 and outputs L_V_Sync, L_H_Sync, L_DE and L_Reserved in synchronization with the internal clock signal P_Clock0.

The data scramblers 210, 212 and 214 receive 1_R[7:0], 1_G[7:0] and 1_B[7:0] from the data latches 202, 204 and 206 and perform scrambling for DC balancing and scrambling for compensation of the skew between channels depending on the state of L_DE from the control latch 208 to obtain 9-bit parallel data S_R[8:0], S_G[8:0] and S_B[8:0], respectively.

The scrambling operations of the data scramblers 210, 212 and 214 will now be described in detail.

(1) Scrambling for DC Balancing

The data scramblers 210, 212 and 214 perform scrambling for DC balancing with respect to the 8-bit parallel data of R, G and B channels received from the data latches 202, 204 and 206, when DE among the control bits is high.

The operation conditions of the data scramblers 210, 212 and 214 will now be described by describing the operation of only the data scrambler 210.

First, if the disparity of currently-input data L_R[7:0] is 0 or a positive value, and an accumulated disparity value is equal to or more than 16, a scrambling operation is enabled.

Second, if the disparity of currently-input data L_R[7:0] is a negative value, and an accumulated disparity value is equal to or less than −16, the scrambler 210 is enabled.

If only one of the two conditions is satisfied, the data scrambler 210 operates to invert all the bits of received video data L_R[7:0]. A header bit having a value of “1” is added at the head of the inverted 8-bit data. The output of the data scrambler 210, S_R[8:0], in this case, is expressed as in the following Equation:

S_{—}R[8:0]={1, −L_{—}R[7:0]}

(wherein “−” denotes an inversion).

If none of the two conditions is satisfied, the originally-received 8-bit video data L_R[7:0] is maintained, and a header bit having a value of “0” is added at the head of the video data. The output of the data scrambler 210, S_R[8:0], in this case, is expressed as in the following Equation:

S_{—}R[8:0]={0, L_{—}R[7:0]}.

Simultaneously, the scrambler 210 adds the disparity of the scrambled data S_R[8:0] to the already-recorded accumulated disparity.

In this way, scrambling for DC balancing within ±16 bit is performed.

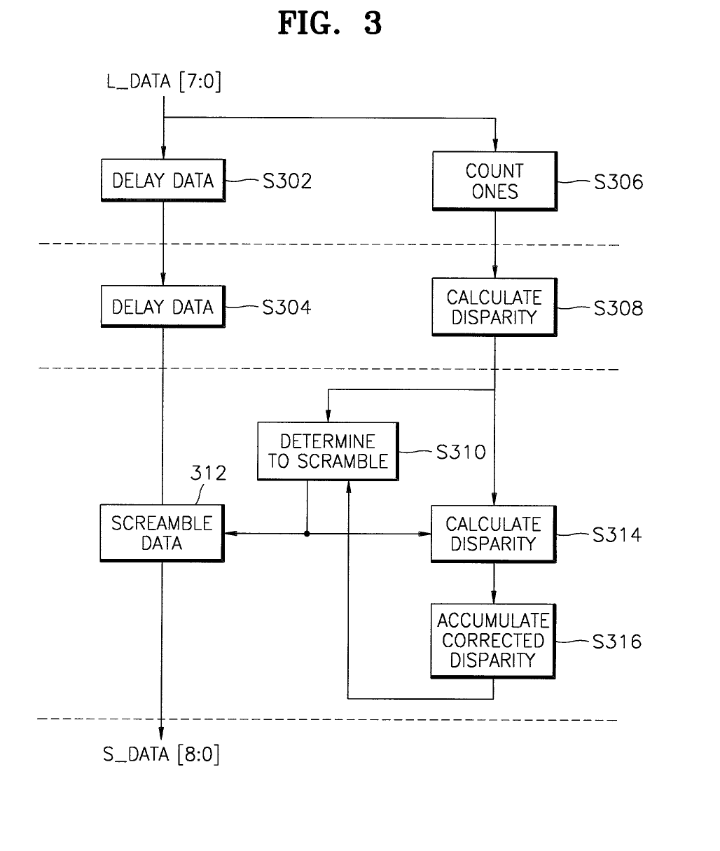

FIG. 3 is a flowchart illustrating the operation of the data scramblers shown in FIG. 2. Hereinafter, the operation of only the data scrambler 210 for R channel will be described as a representative example.

In steps S302 and S304, received video data L_R[7:0] is delayed for one clock and delayed for another clock.

In step S306, the number of bits of “0” in the received video data L_R[7:0] is counted.

In step S308, the disparity of the received video data L_R[7:0] is calculated on the basis of the results of the counting in step S306.

In step S310, scrambling or non-scrambling is determined by the disparity of the received video data L_R[7:0] and the accumulated disparity of the scrambler 210.

In step S312, the delayed video data L_R[7:0] is scrambled according to the result determined in step S310.

In step S314, scrambled data S_R[8:0] in step S312 is received, and the disparity of the scrambled data is calculated.

In step S316, the disparity calculated in step S314 is accumulated.

(2) Scrambling for Compensation of the Skew Between Channels

When a control bit DE is low, scrambling for the compensation of the skew between channels is performed. At this time, the accumulated disparity of the scrambler 210 is reset to be 0, and 9-bit Sync_Video_Code is output. Sync_Video_Code, which is a DC balanced type, is expressed as in the following Equation:

Sync_Video_Code[8:0]=[111000101].

The control encoder 216 performs an encoding operation for DC balancing and an encoding operation for compensation of the skew between channels, with respect to received 4-bit control data.

i) Encoding for DC Balancing

The received control data is encoded according to the following encoding rule.

| | | |
|---|---|---|
| bit 3: V-Sync | → | bit 8: - V_Sync |
| | | bit 7: - V_Sync |
| bit 2: H-Sync | | bit 6: V_Sync |
| | | bit 5: H_Sync |
| bit 1: DE | | bit 4: - H_Sync |
| | | bit 3: DE |
| bit 0: reserved | | bit 2: - DE |
| | | bit 1: reserved |
| | | bit 0: - reserved |

wherein “−” denotes an inversion.

The DC balancing of control data is achieved within a total of ±1 bit, and it is also applied in the skew compensation to be described later.

ii) Encoding for Compensation of the Skew Between Channels

Received 4-bit control data is encoded into 9-bit data in the following rules.

First, the first two bits (bits 8 and 7) are the same.

Second, the last two bits (bits 1 and 0) are in a logically-NOT (opposite) relationship.

Third, bits 7 and 6 are in a logically-NOT (opposite) relationship.

Fourth, bits 5 and 4 are in a logically-NOT (opposite) relationship.

As can be seen from the above rules for encoding control data to compensate for skew, these rules can be equally applied to the encoding for DC balancing. That is, the control encoder 216 encodes received control bits according to the four encoding rules, so that the digital video data transmitter can maintain the DC balancing and compensate for the skew between channels.

The parallel-to-serial converters 220, 222, 224 and 226 convert the 9-bit parallel data from the data scramblers 210, 212 and 214 and the 9-bit parallel control data from the matching device 218 into 9-bit serial data Out_R, Out_G, Out_B and Out_Control, respectively, in synchronization with the internal clock signal, and output the 9-bit serial data Out_R, Out_G, Out_B and Out_Control to corresponding channels.

The PLL 228 receives a clock signal Clock from the LCD graphic controller 102 shown in FIG. 1 and outputs an internal clock signal P_Clock0 and a clock signal Out_Clock via a clock channel in synchronization with the clock signal Clock.

The internal clock signal P_Clock0 is provided to the latches 202, 204, 206 and 208, the scramblers 210, 212 and 214, the control encoder 216 and the parallel-to-serial converters 220, 222, 224 and 226.

A power-on reset unit 230 resets the operation of the device shown in FIG. 2 when power is turned on.

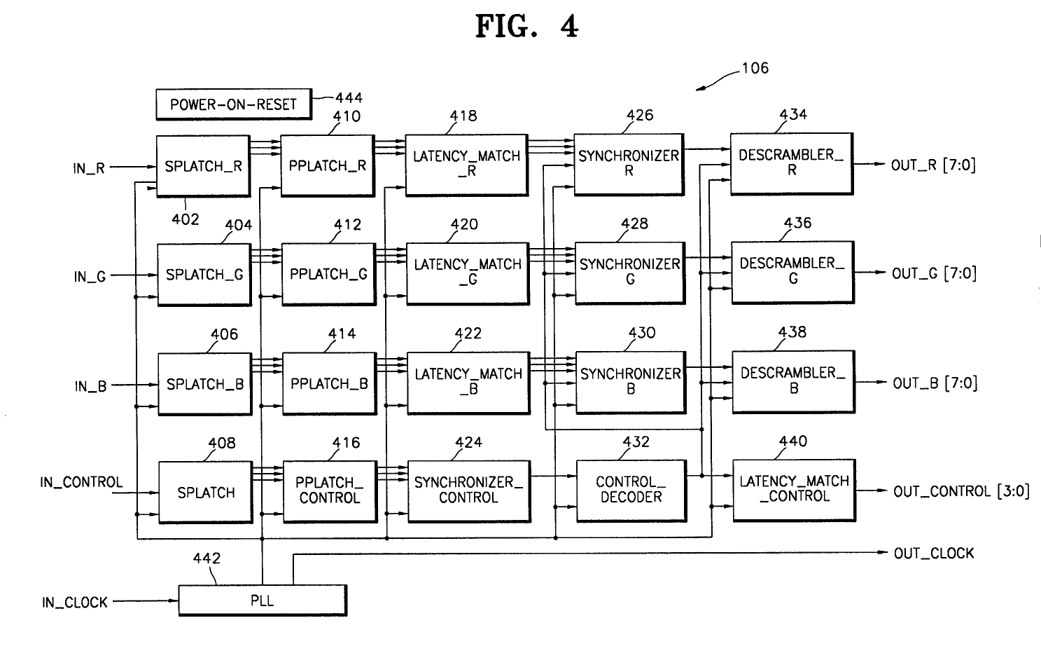

FIG. 4 is a block diagram illustrating the configuration of the digital video data receiver 106 shown in FIG. 1. The receiver 106 includes serial-to-parallel converters 402, 404, 406 and 408, latches 410, 412, 414 and 416, matching devices 418, 420 and 422, a synchronization control unit 424, synchronizers 426, 428 and 430, a control decoder 432, descramblers 434, 436 and 438, a control matching device 440 and a PLL 442. The serial-to-parallel converters 402, 404, 406 and 408 latch 9-bit serial data of R/G/B/Control channels and convert the 9-bit serial data into 9-bit parallel data. The latches 410, 412, 414 and 416 latch the 9-bit parallel data output from the serial-to-parallel converters 402, 404, 406 and 408, respectively.

The receiver 106 receives serial data, and 9-bit graphic data and 9-bit control data are transmitted for each clock. Meanwhile, the receiver 106 outputs parallel data, and 8-bit graphic data and 4-bit control data are transmitted for each clock.

The serial-to-parallel converters 402, 404, 406 and 408 latch 9-bit serial data In_R, In_G, In_B and In_Control received from the transmitter 104 shown in FIG. 1, and convert the 9-bit serial data into 9-bit parallel data. Here, the 9-bit serial data In_R, In_G, In_B and In_Control are the same as the 9-bit serial data Out_R, Out_G, Out_B and Out_Control output from the transmitter 104 as shown in FIG. 2.

9-bit parallel data output from the serial-to-parallel converters 402, 404 and 406 are provided to the synchronizers 426, 428 and 430 via the latches 410, 412 and 414 and the matching devices 418, 420 and 422, respectively.

The 9-bit parallel control data output from the serial-to-parallel converter 408 is provided to the control synchronizer 424 via the latch 416.

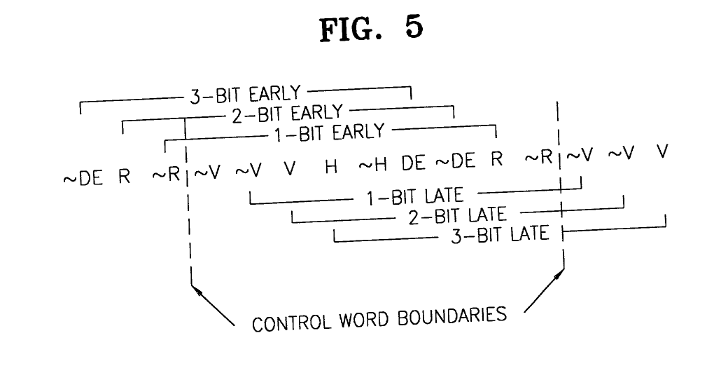

FIG. 5 illustrates the operation of the control synchronizer 424 shown in FIG. 4. The serial-to-parallel converter 408 groups control data received in series via a control channel in synchronization with an internal clock signal in units of 9 bits and converts each group of 9 bits into 9-bit parallel data. Here, the internal clock signal is generated in synchronization with clock data In_Clock transmitted via a clock channel, but it is doubtful whether the serial-to-parallel converter 408 has truncated the encoded control data in units of 9 bits starting from the exact beginning portion of the encoded control data. The control synchronizer 424 adopts the encoding conditions for control data used in the control encoder 216 of FIG. 2 in order to accurately ascertain the beginning and end portions of control data.

In FIG. 5, a phrase “control word boundaries” represents a case in which control data is truncated starting from the exact beginning portion of the control data. Terms 1-bit early, 2-bit early and 3-bit early represent cases in which the control data is truncated starting from one bit, two bits and three bits ahead of the beginning portion of control data, respectively. Terms 1-bit late, 2-bit late and 3-bit late represent cases in which the control data is truncated starting from one bit, two bits and three bits after the beginning portion of the control data, respectively.

The control synchronizer 424 detects the six abnormal cases shown in FIG. 5 using the four encoding rules used by the control encoder 216 of FIG. 2, as in the following way.

The 1-bit early case violates the third condition.

The 2-bit early case violates the first condition.

The 3-bit early case violates the fourth condition.

The 1-bit late case violates the first condition.

The 2-bit late case violates the second condition.

The 3-bit late case violates the first condition.

The control data can be accurately arranged within a maximum of ±3 bits by the above detection method. The control synchronizer 424 outputs 9-bit data when the case “control word boundaries” is judged.

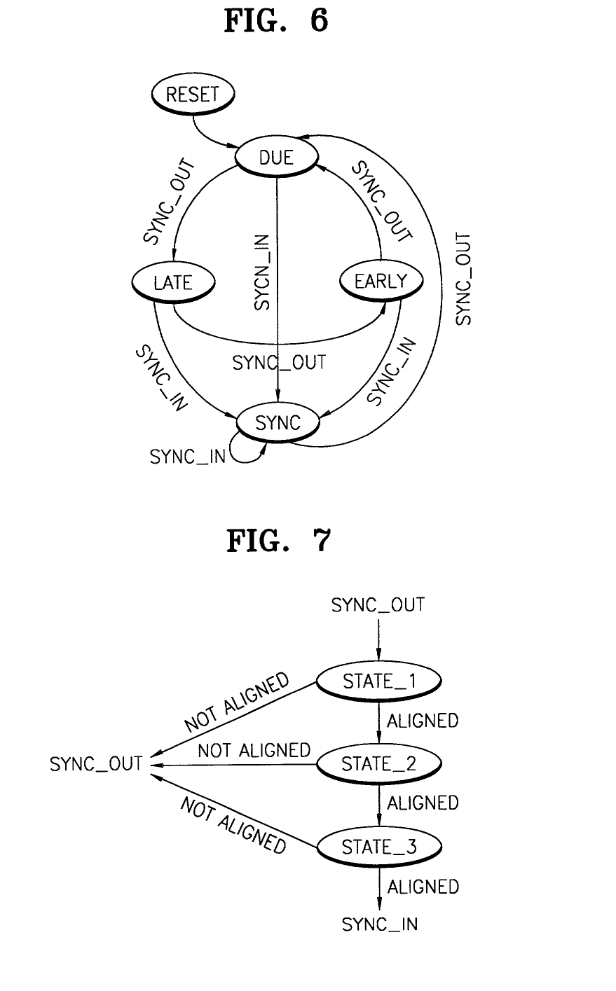

FIGS. 6 and 7 are state transition diagrams illustrating the operation of the control synchronizer 424 shown in FIG. 4. The control synchronizer 424 determines whether the received 9-bit control data is true or false, depending on whether the received control data conforms to the ending conditions. If it is determined that the received 9-bit control data is true, the received 9-bit control data is defined as Sync_In, and if it is determined that the received 9-bit control data is false, the received 9-bit control data is defined as Sync_Out.

Here, Sync_In or Sync_Out is expressed as in the following equation:

Sync_In or Sync_Out=(bit[8] XOR bit[7]) AND (bit[7] XNOR−bit[6]) AND (bit[5] XNOR−bit[4]) AND (bit[1] XNOR−bit[0])

wherein “−” denotes an inversion.

In FIG. 6, six SYNC states such as DUE, LATE, EARLY, SYNC_IN, SYNC_OUT, and SYNC are shown. In each of the DUE state, the LATE state and the EARLY state, if control data aligned accurately in the sequence from bit 8 to bit 0 is received three or more times, each state enters the SYNC state via a SYNC_IN state. If control data aligned accurately in the sequence from bit 8 to bit 0 is received less than three times, each state is transited to the next state via a SYNC_OUT state, and searches for a state for proper alignment. In the SYNC state, when error is generated on the properly-aligned control data fifteen or more times, the SYNC state returns to the DUE state via a SYNC_OUT state, and then repeats the above series of processes.

FIG. 7 is a state transition diagram illustrating the detailed operation of the DUE state, the LATE state and the EARLY state shown in FIG. 6. As shown in FIG. 7, each of the DUE state, the LATE state and the EARLY state enters a state STATE_1 via a SYNC_OUT state, passes through a state STATE_2 and a state STATE_3 whenever accurately-aligned control data is received, and finally enters a state SYNC_IN. That is, when each of the DUE state, the LATE state and the EARLY state receives properly-aligned control data three times successively, the state enters the state SYNC_IN.

If each of the states STATE_1, STATE_2 and STATE_3 does not receive properly-aligned control data, the state enters the state SYNC_OUT.

Through the above-described process, the control synchronizer 424 can transmit control data accurately aligned in units of 9 bits to the control decoder 432.

The control decoder 432 decodes 4 control bits among the 9 bits of the control data received from the control synchronizer 424. The decoding is performed in a reverse way to the encoding method used by the control encoder 216 of FIG. 2.

The synchronizers 426, 428 and 430 accurately align 9-bit data of R, G and B channels using Sync_Video_Code through the same operation as in the control synchronizer 424 when a bit DE restored by the control decoder 432 is low.

Control data is aligned using an encoding rule determined between bits, while video data is aligned using Sync_Video_Code.

That is, in the synchronizers 426, 428 and 430, the states DUE, LATE and EARLY enter the state SYNC via the state SYNC_IN if properly-aligned Sync_Video_Code is received three or more times. On the other hand, if properly-aligned Sync_Video_Code is received less than three times, each of the states DUE, LATE and EARLY is transited to its next state to search for a state to achieve proper alignment. In the SYNC state, when error is generated on the properly-aligned control data fifteen or more times, the SYNC state returns to the DUE state via a SYNC_OUT state, and then repeats the above series of processes.

The data descramblers 434, 436 and 438 perform descrambling using the bit DE restored by the control decoder 432. When the restored bit DE is low, the data descramblers 434, 436 and 438 all output zero by disregarding Sync_Video_Code received from the data synchronizers 426, 428 and 430. When the restored bit DE is high, the data descramblers 434, 436 and 438 descramble the 9-bit data received from the data synchronizers 426, 428 and 430, respectively.

When the bit DE is high, the data descramblers 434, 436 and 438 operate in the following conditions.

First, when a header bit value is 1, 8 bits except for the header bit are inverted and output.

Second, when a header bit value is 0, 8 bits except for the header bit are output without change.

Data descrambled by the descramblers 434, 436 and 438 is output as Out_R[7:0], Out_G[7:0] and Out_B[7:0], respectively, in synchronization with the output clock signal Out_Clock.

The control matching unit 440 delays the 4-bit parallel control data output from the control decoder 432 in order to match the time of the 8-bit parallel graphic data from the descramblers 434, 436 and 438 with the time of the 4-bit parallel control data from the control decoder 432.

A power-on reset unit 444 resets the operation of the receiver 106 shown in FIG. 4 when power is turned on.

As described above, in a digital video data transmission method according to the present invention, the DC balancing within a channel is maintained, and the skew between channels can be compensated for, when digital video data is transmitted in series through corresponding channels.

While the present invention has been described with respect to the particular embodiments, it will be apparent to those skilled in the art that various changes and modifications may be made without departing from the spirit and scope of the invention as defined in the following claims.

What is claimed is:

1. A method of transmitting digital video data made up of graphic data, control data and clock data in series through corresponding channels, the method comprising:
calculating a disparity representing a degree of direct current (DC) balancing of the graphic data whenever the graphic data is transmitted;
accumulating calculated disparities to produce an accumulated disparity whenever the graphic data is transmitted;
checking whether the accumulated disparity reaches a predetermined critical value; and
performing scrambling in which, when the accumulated disparity does not reach the predetermined critical value, the graphic data is transmitted without change, and when the accumulated disparity reaches the predetermined critical value, the graphic data is inverted.

2. The method of claim 1, wherein the disparity is the difference between the number of bits of 0 and the number of bits of 1.

3. The method of claim 2, wherein the predetermined critical value includes an upper limit and a lower limit, and, in the scrambling step, when the disparity of the graphic data is negative and the accumulated disparity is at or below the lower limit, the graphic data is inverted and output.

4. The method of claim 3, wherein, in the scrambling step, when the disparity of the graphic data is positive and the accumulated disparity is at or over the upper limit, the graphic data is inverted and output.

5. The method of claim 1, further comprising adding a header bit to represent that the graphic data has been inverted.

6. The method of claim 1, wherein the control data includes a data enable (DE) bit representing that the graphic data is effective, and the method is performed in a state where the DE bit represents that the graphic data is effective.

7. The method of claim 6, further comprising transmitting a predetermined sync pattern in a state where the DE bit represents that the graphic data is not effective.

8. The method of claim 7, wherein the difference between the numbers of bits of 0 and bits of 1 constituting the sync pattern is a predetermined value or smaller.

9. The method of claim 8, wherein the predetermined value is ±1.

10. The method of claim 7, further comprising adding surplus bits having bit values determined by the original value of the control data to the control data.

11. The method of claim 10, wherein the number of surplus bits is obtained by subtracting the number of bits of control data from the sum of the number of bits of graphic data and a header bit having a value of 1.

12. The method of claim 11, wherein the bit value of each of the surplus bits is opposite to the bit value of each of the bits of the control data.

13. The method of claim 12, wherein the bits of the control data and the surplus bits are aligned alternately.

14. A method of receiving and reproducing digital video data made up of graphic data, control data and clock data wherein the digital video data is transmitted by channels in series, having the graphic data inverted or non-inverted to achieve DC balancing and compensate for the skew between channels and transmitted having a sync pattern with a specific bit pattern inserted therein, and the control data encoded and transmitted having surplus bits added according to a certain encoding rule to achieve the DC balancing and compensate for skew between channels, the method comprising:
ascertaining the beginning portion of effective graphic data by detecting the specific bit pattern from the serially-transmitted graphic data;
truncating graphic data starting from its ascertained beginning portion in units of a predetermined number of bits; and
restoring the truncated graphic data to data that has not been inverted or non-inverted and encoded.

15. The method of claim 14, wherein the transmitted graphic data includes a header bit representing whether the graphic data has been inverted or non-inverted, and, in the restoring step, the truncated graphic data is restored to data that has not been inverted or non-inverted and encoded, with reference to the header bit.

16. The method of claim 15, further comprising:
ascertaining the beginning portion of control data using the encoding rule applied to encode the serially-transmitted control data;
truncating the control data starting from its ascertained beginning portion in units of a predetermined number of bits; and
restoring the truncated control data to control data that has not been encoded.

17. An apparatus for transmitting digital video data made up of graphic data, control data and clock data in series by channels, the apparatus comprising:
a scrambler for scrambling the graphic data to achieve DC balancing and compensate for skew between channels;
a control encoder for encoding the control data to achieve the DC balancing and compensate for the skew between channels;
a graphic data parallel-to-serial converter for converting an output of the scrambler into serial data and outputting the serial data to a graphic channel;
a control data parallel-to-serial converter for converting the output of the control encoder into serial data and outputting the serial data to a control channel; and
a phase locked loop for receiving the clock data and providing an operation clock to the scrambler, the control encoder, the graphic data parallel-to-serial converter and the control data parallel-to-serial converter or outputting the operation clock to a clock channel.

18. The apparatus of claim 17, wherein the scrambler calculates a disparity representing a degree of the DC balancing of graphic data to be transmitted whenever graphic data is received, accumulates the calculated disparity whenever graphic data is received, checks if the accumulated disparity reaches a predetermined critical value, and outputs received graphic data without change if the accumulated disparity does not reach the predetermined critical value and inverts the received graphic data if the accumulated disparity reaches the predetermined critical value.

19. The apparatus of claim 18, wherein the disparity is the difference between the numbers of bits of 0 and bits of 1 of the received graphic data.

20. The apparatus of claim 19, wherein the predetermined critical value includes an upper limit and a lower limit, and the scrambler inverts the received graphic data if the disparity of currently-received graphic data is negative, and the accumulated disparity is at or below the lower limit.

21. The apparatus of claim 20, wherein the scrambler inverts the received graphic data if the disparity of the currently-received graphic data is positive, and the accumulated disparity is at or over the upper limit.

22. The apparatus of claim 18, wherein the scrambler adds a header bit to represent inversion or non-inversion of the graphic data.

23. The apparatus of claim 18, wherein the control data includes a data enable (DE) bit representing that the graphic data is effective, and the scrambler performs data inversion or non-inversion in a state where the DE bit represents that the graphic data is effective.

24. The apparatus of claim 23, wherein the scrambler outputs a predetermined sync pattern in a state where the DE bit represents that the graphic data is not effective.

25. The apparatus of claim 24, wherein the difference between the numbers of bits of 0 and bits of 1 constituting the sync pattern is a predetermined value or smaller.

26. The apparatus of claim 25, wherein the predetermined value is ±1.

27. The apparatus of claim 18, wherein the control encoder adds surplus bits having bit values determined by the original value of the control data to the control data.

28. The apparatus of claim 27, wherein the number of surplus bits is obtained by subtracting the number of bits of received control data from the sum of the number of bits of received graphic data and a header bit having a value of 1.

29. The apparatus of claim 28, where the bit value of each of the surplus bits is opposite to the bit value of each of the bits of received control data.

30. The apparatus of claim 29, wherein the bits of the received control data and the surplus bits are aligned alternately.

31. An apparatus for receiving and reproducing digital video data made up of graphic data, control data and clock data, the digital video data transmitted by channels in series, having the graphic data inverted or non-inverted to achieve DC balancing and compensate for skew between channels and the control data encoded to achieve the DC balancing and compensate for the skew between channels, the apparatus comprising:
a descrambler for inverting or non-inverting the transmitted graphic data depending on the state of DC balancing and outputting a parallel signal in synchronization with a clock signal transmitted via a clock channel;
a control decoder for decoding transmitted control data and outputting a parallel signal in synchronization with the clock signal transmitted via the clock channel; and
a phase locked loop for receiving the clock signal transmitted via the clock channel and generating a clock signal to be provided to the descrambler and the control encoder or outputting the generated clock signal.

32. The apparatus of claim 31, wherein the transmitted graphic data includes a header bit representing whether the graphic data has been inverted or non-inverted, and the descrambler inverts or non-inverts transmitted data depending on the value of the header bit.

33. The apparatus of claim 32, further comprising a synchronizer for truncating the transmitted graphic data by detecting a sync pattern and providing the truncated graphic data to the descrambler, wherein the sync pattern is transmitted while the graphic data is ineffective.

34. The apparatus of claim 33, wherein the synchronizer truncates the transmitted graphic data when the sync pattern is properly received at least a predetermined number of times.

35. The apparatus of claim 34, wherein the synchronizer is reset when error is generated on the graphic data at least a predetermined number of times.

36. The apparatus of claim 33, further comprising a control synchronizer for truncating the transmitted control data by detecting a predetermined encoding rule and providing the truncated control data to the control decoder, wherein the control data is encoded according to the predetermined encoding rule.

37. The apparatus of claim 36, wherein the control synchronizer truncates the transmitted control data and provides the truncated control data to the control decoder, when the control data is properly received at least a predetermined number of times.

38. The apparatus of claim 37, wherein the control synchronizer is reset when error is generated on the control data at least a predetermined number of times.

39. The apparatus of claim 31, further comprising a control matching unit for delaying the control data output from the control decoder in order to match the time of the control data output from the control decoder with the time of the graphic data output from the descrambler.
